(19) United States
(12) Patent Application Publication
(10) Pub. No.: US 2023/0285840 A1
(43) Pub. Date: Sep. 14, 2023

(54) Collectable Resale Protection

(71) Applicant: Lexmark International, Inc., Lexington, KY (US)

(72) Inventors: Scott R. Castle, Umatilla, FL (US); Steve B. Fischer, Lexington, KY (US); Kate O. Giuliani, Lexington, KY (US); Daniel L. Thomas, Lexington, KY (US)

(21) Appl. No.: 17/692,871

(22) Filed: Mar. 11, 2022

(51) Int. Cl. A63F 1/06; A63F 1/02; G01R 33/12; H04L 9/32

(52) U.S. Cl. CPC A63F 1/062; A63F 1/02; G01R 33/1276; H04L 9/3278; H04L 2209/12

(57) ABSTRACT

To better protect collectible cards, a better tamper evident case is needed, one that counterfeiters cannot replicate. Disclosed is a collectible card case where each edge is physical unclonable function (“PUF”) material that counterfeiters cannot replicate. Further disclosed is a thermally sealed bag with an integrated PUF material where each bag is unique and unclonable, and a device for sealing and measuring the magnetic and optical properties of the PUF material. Finally, a reusable hard case is disclosed with features that allow for a one-time use PUF security clip.

### CROSS REFERENCES TO RELATED APPLICATIONS

This application claims priority and benefit under 35 U.S.C. 119(e) from U.S. provisional application No. 63/159,949 titled “Collectable Resale Protection,” having a filing date of Mar. 11, 2021.

### BACKGROUND

### 1. Field of the Invention

This invention relates generally to a collectible card case where each edge is physical unclonable function (“PUF”) material that counterfeiters cannot replicate.

### 2. DESCRIPTION OF THE RELATED ART

The authentication system disclosed in U.S. Pat. No. 9,553,582 is based on a unique physical object, where the unique physical object is a PUF (Physical Unclonable Function) that contains magnetic particles that are random in size, shape and orientation, which when magnetized generate a complex and random (in amplitude and direction) magnetic field near the surface of the PUF object.

### SUMMARY OF THE INVENTION

To better protect collectible cards, a better tamper evident case is needed, one that counterfeiters cannot replicate. Disclosed is a collectible card case where each edge is physical unclonable function (“PUF”) material that counterfeiters cannot replicate.

Further disclosed is a thermally sealed bag with an integrated PUF material where each bag is unique and unclonable, and a device for sealing and measuring the magnetic and optical properties of the PUF material.

Finally, a reusable hard case is disclosed with features that allow for a one-time use PUF security clip.

These improvements and optimizations will be described in detail.

### BRIEF DESCRIPTION OF THE DRAWINGS

Having thus described the invention in general terms, reference will now be made to the accompanying drawings, which are not necessarily drawn to scale, and wherein:

FIG. 1 shows a trading card case in two parts with a physical unclonable function element.

FIG. 2 shows the parts of the trading card case in FIG. 1 joined to close the case.

FIG. 3A shows a top view of a sealed trading card case.

FIG. 3B shows a trading card case with a continuous magnetic PUF area.

FIG. 4 shows a trading card case with gaps in the magnetic PUF area.

FIG. 5A shows a thermally sealed barrier bag.

FIG. 5B shows a thermally sealed bag with an integrated PUF material.

FIG. 5C shows a how a bag may be opened by tearing across the magnetic PUF material.

FIG. 6 shows a device for sealing a thermally sealed bag with an integrated PUF material.

FIG. 7A shows a magnetic PUF bag positioned for insertion in an opening of the device.

FIG. 7B shows a magnetic PUF bag position after insertion in an opening of the device for thermal sealing.

FIG. 7C shows a magnetic PUF bag after conveyance through a channel in the device after thermal sealing to record optical and magnetic properties of the magnetic PUF.

FIG. 8A shows a typical hard case for packaging collectable cards.

FIG. 8B shows a reusable hard case with features that allow for a PUF security clip.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology, terminology and dimensions used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having” and variations thereof herein is meant to encompass the items listed thereafter and equivalents thereof as well as additional items. Terms such as “about” and the like are used to describe various characteristics of an object, and such terms have their ordinary and customary meaning to persons of ordinary skill in the pertinent art. The dimensions of the magnetic particles, separations between particles and sensor locations are interrelated and can be proportionally scaled with respect to each other to provide different dimensional solutions.

The present invention is described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

### PUF Magnetic Perimeter Card Case

Today in the collectible card market, cards are often sent to companies to evaluate their authenticity and quality. Once assessed, the cards are given a custom label with information such as the name of the image depicted on the card, the date the card was printed, and a rating designating the quality of the card with respect to the original condition. These labels often have features to prevent duplication, such as holograms, microprint, and fugitive ink. The card and label are then placed into a permanent enclosure to preserve both.

In this context, the main tamper evident feature is the custom label; yet counterfeiters today will break open the case, steal the legitimate label and replace the card with a fake. Once the case is glued back together or replaced with an identical case, the fake card can be sold for the original price while retaining the original for another sale.

To better protect collectible cards in this space, a better tamper evident case is needed, one that counterfeiters cannot replicate. Relying on the inserted label to be the protection against fraud only emboldens the counterfeiters. Once a buyer sees the correct label, they may ignore signs of a counterfeit card.

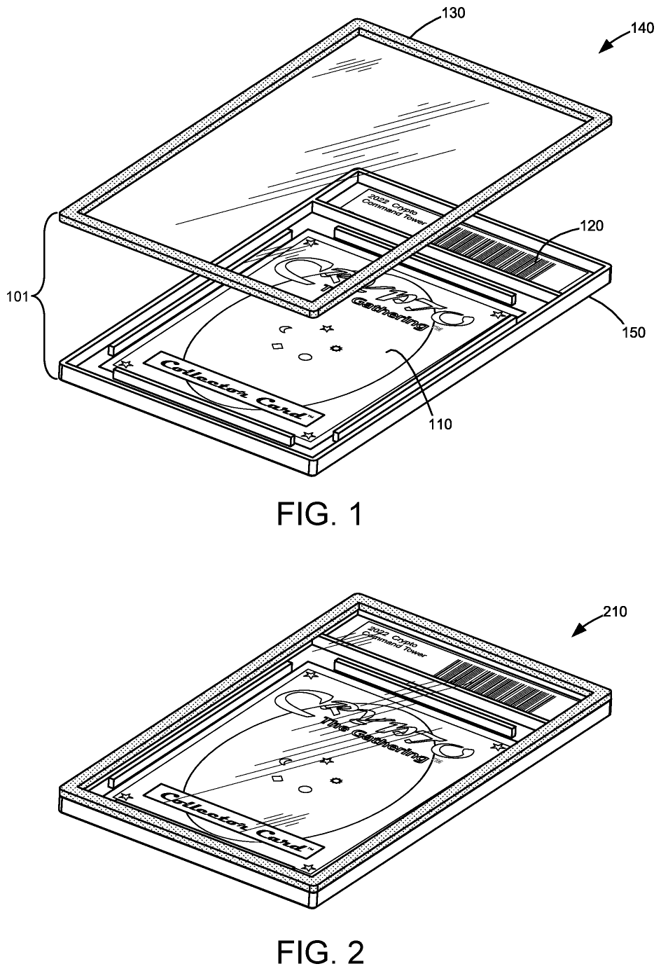

Creating a case where each edge is physical unclonable function (“PUF”) material that counterfeiters cannot replicate is a solution. Shown in FIGS. 1 and 2 is a trading card case 210 in two parts 101, a cover 140, and a base container 150. Bonding the two pieces can be accomplished via mechanical locking, adhesives, or ultrasonic welding. The case 210 geometry can be scaled to contain any required object.

The case can also be a single piece with a living hinge connecting the cover and base container.

The edge material 130 is loaded with randomly magnetized particles, such as flakes of an alloy of neodymium, iron and boron (“NdFeB”) or Samarium Cobalt (“SmCo”). The case edge may be, for example, 3.5 mm in width so as to not impinge on the visibility of the collectible card inside. The thickness of the magnetic edge material may be, for example, 1.5 mm to allow for ease of molding operation.

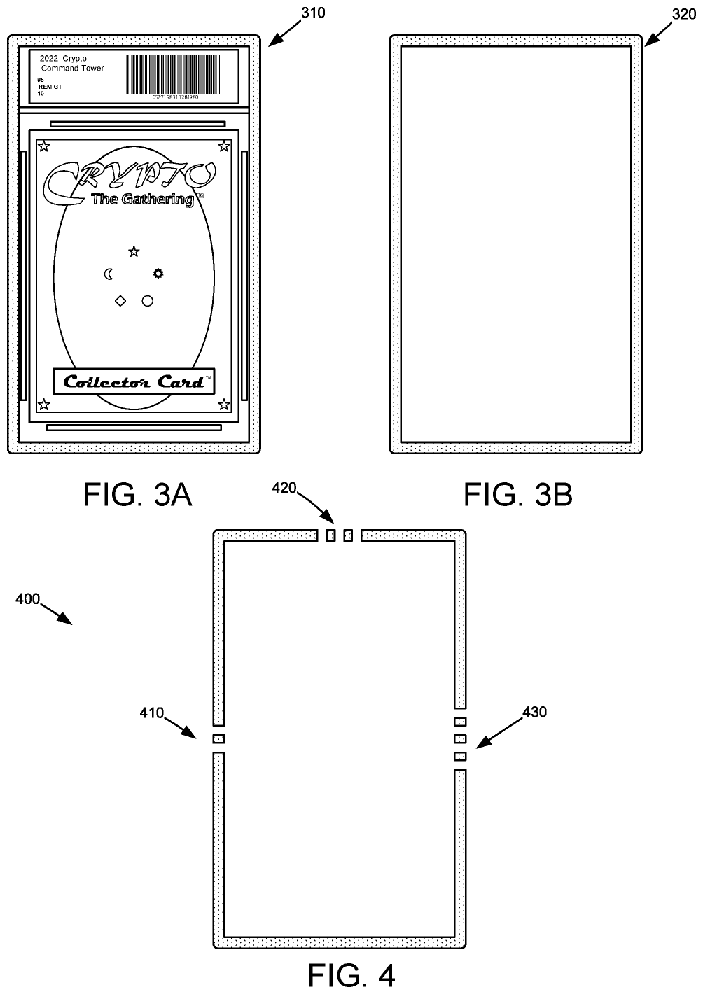

A top view of the sealed case 310 is shown in FIG. 3A, with the magnetic signature strip 320 shown in FIG. 3B. After bonding the two sides of the case together, the clear case and magnetically loaded edge are flush for best aesthetics. For ease of magnetic registration, the edge can be made slightly taller than the clear base.

The edge material 140 has unique magnetic and optical properties.

After sealing the case, each edge may be magnetically registered, for example through a linear swipe, similar to a credit card, and thus associating the magnetic and/or optical properties with the card inside and its pertinent information. The magnetic signature can be registered via swiping each edge progressively through a single sensor, or all at once via an array of sensors.

A picture of the sealed case may be taken to record the unique optical properties. Utilizing the visual signature allows for immersive interactions for a consumer via means such as a smartphone device.

If the case has been tampered with, the magnetic signature will be disturbed, and upon another swipe, it will no longer be recognizable and deemed invalid.

The magnetic PUF areas may be continuous 310 as shown in FIG. 3B, or by adding fiducials via one 410, two 420, or three 430 voids in the magnetic PUF areas as shown in FIG. 4, for example, or post magnetized spots to differentiate each side help with magnetic registration.

The magnetic PUF material is bonded to the transparent top case during the molding process. Bonding the PUF material to the transparent case can be done simultaneously via co-injection or in a two-step over-molding process. Gaps in the magnetic material are created by filling in space with the case material.

The distance for a given fiducial or between fiducials is a function of the chosen magnetic reading sensitivity and swiping velocity. The fiducial pattern may include encoding a specific side, a magnetic reading direction, or information of the subject matter enclosed in the case itself. The example shown in FIG. 4 has gaps to differentiate each side via the number of openings present. Biasing these gaps to one side or the other allows for easy identification of the direction the case is being moved.

Further, small voids in the magnetic field may be used allow each side to have a numerical value. These could also be post-magnetized spots.

### PUF Tamper Evident Thermally Sealed Bag

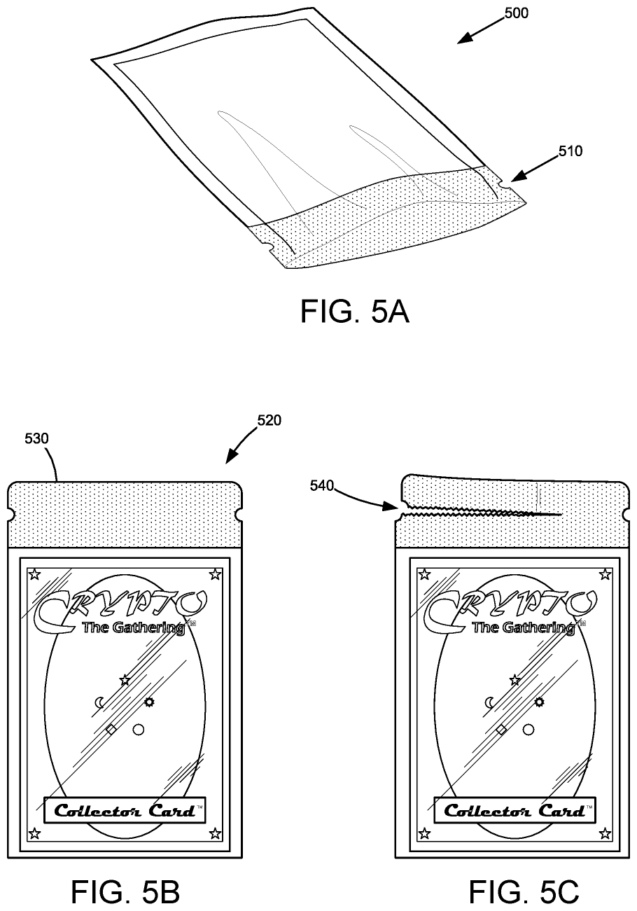

Thermally sealed barrier bags 500 shown in FIG. 5A are a common means to package any number of items. Once sealed, the top portion 510 must be torn open to allow access to the contents. These bags are readily available on the market. It is not difficult for counterfeiters to create fake products with legitimate-looking packaging.

A bag 520 with an integrated PUF material 530 shown in FIG. 5B creates a solution where each bag is unique and unclonable. Like standard barrier bags, an item can be placed inside and then thermally sealed across the PUF portion 530.

The PUF material may be co-extruded with a clear plastic base (e.g., polypropylene). The two disparate materials may also be thermally-bonded and cut and shaped to form various sizes.

After the bag is thermally sealed, the magnetic and optical signatures may be read and associated with the contents. Opening the bag 520 via tearing across the magnetic PUF material 540 shown in FIG. 5C destroys the registered signatures. Rereading the magnetic signature will show evidence of tampering with the bag.

### PUF Bag Seal and Linear Swipe Enrollment Device

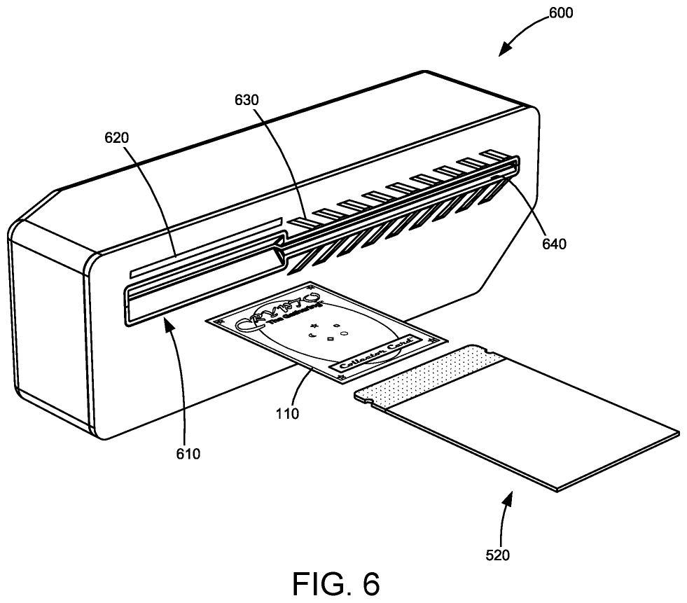

To utilize thermally sealed PUF bags, a device 600 shown in FIG. 6 described is used. The device 600 combines a thermal element 610 to seal the bag 520, and a channel 640 that the bag is swiped through to read and register the unique magnetic and optical signature.

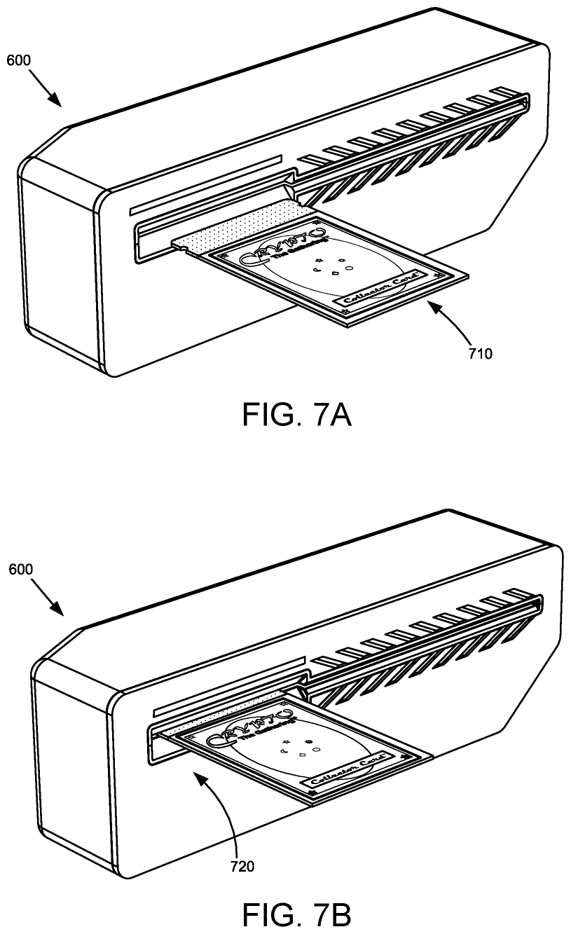

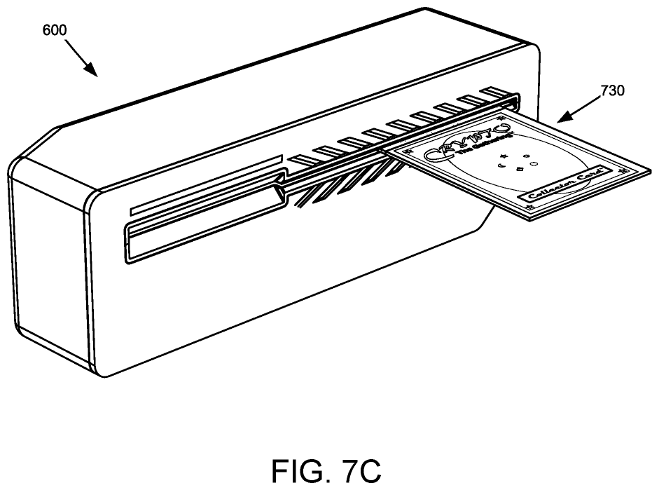

A collectable card 110 is place in a magnetic PUF bag 520 and brought to the opening 610 of the device 600. The magnetic PUF bag 520 is inserted in the sealing device 600 as shown in FIG. 7B. After an indicator light 620 signals the sealing of the PUF bag 520, the bag is conveyed through a channel 640 in the device 600 as shown in FIG. 7C. The means of conveyance may be manual or by a mechanically driven system to ensure consistent linear speed for the highest image and magnetic signature quality. In the channel 640 is a camera (this could also be done with an in-line scanner) and magnetic field reading sensor, neither shown. The image and magnetic signature are used to validate the bag in the future.

### PUF Tamper Evident Case Lock

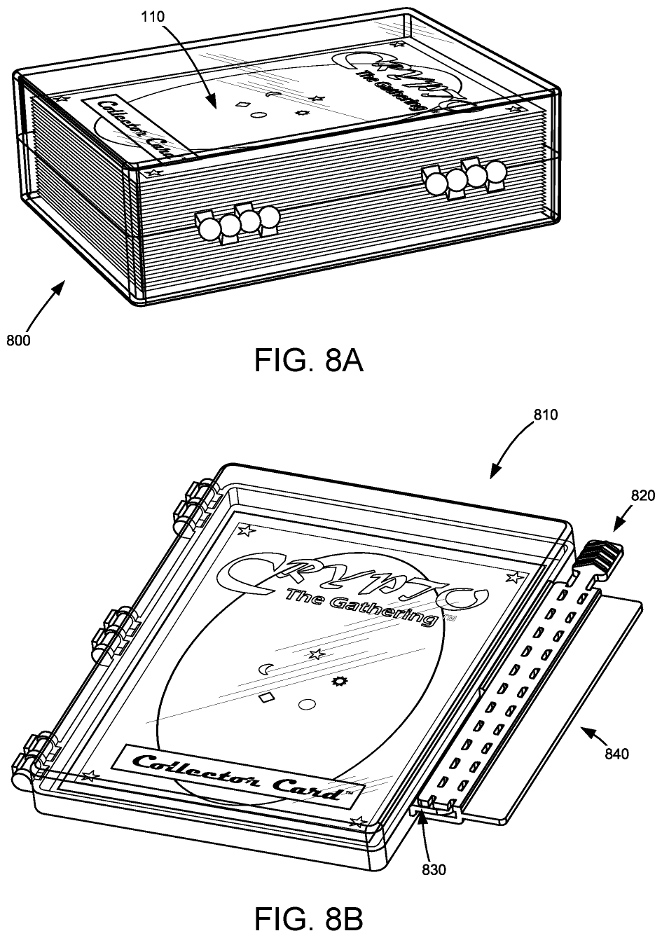

Often when buyers purchase cards 110 on the resale market, the cards are packed in hard cases 800, as shown in FIG. 8A. The cases 800 are solely for the protection of the cards and provide no security features. If this case was returned to the seller, there is no protection from theft.

For a more secure experience for the seller, proposed is a reusable hard case 810 shown in FIG. 8B with features that allow for a PUF security clip 840. The security clip 840 has a one-time snap 830 to seal the case 810. The edge may be thin to allow for the magnetic signature to be registered via a linear swipe. If a buyer chooses to keep the cards, the seal is broken using the integrated tear portion 820. Once torn, the clip can no longer be used. If a buyer chooses to return the contained item and has not broken the seal, the seller can swipe the clip to ensure the authenticity and integrity of the case.

The security clip slides on and permanently snaps onto features molded into either side of the case. Once the security clip is affixed, the case can only be opened by tearing through the security clip's perforated region or destroying the case itself.

The security clip is made from polypropylene to allow for usage of perforated tear features. Using other materials such as high-density polyethylene is also viable. The security clip can be used on various container sizes so long as it has the proper mating features.

We claim:

1. A container case base with a tamper evident edged cover for multifactor authentication comprising:
a base container for creating a rim surface to accept a cover;
the cover for the base container where the rim of the cover contains magnetic and optical particles;
the base and cover are substantially made of vinyl, PET, polyester, nylon or other rigid or flexible materials;
wherein the cover is affixed to the base by gluing, welding or locking, and the affixing method will not separate without disturbing the authentication features, and the authentication is measured by a magnetic sensor or optical image that is compared to similar enrollment.

2. The tamper evident cover of claim 1, where the rim containing magnetic or optical particles is between 2 mm to 10 mm wide.

3. A folded container with a tamper evident edge for multifactor authentication comprising:
a base film for creating a rim surface to accept a fold to create a cover with a sealed flap;
the sealed cover flap contains magnetic and optical particles;
the sealed cover flap is created by gluing, welding or locking;
the base and cover are substantially made of vinyl, PET, polyester, nylon or other rigid or flexible materials;
wherein the affixing method will not separate without disturbing the authentication features and the authentication is measured by a magnetic sensor or optical image that is compared to similar enrollment.

4. A closed container case that has exposed edges to accept a tamper sealing clip comprising:
a locking mechanism that covers exposed edges cannot be removed without pulling the tab;
the locking mechanism contains magnetic and optical particles; and
the locking mechanism has interlocking barbs.
